(19) United States
(12) Patent Application Publication
(10) Pub. No.: US 2026/0226580 A1
(43) Pub. Date: Aug. 6, 2026

(54) DEEP EUTECTIC SOLVENTS FOR REPAIRING ELECTRODE MATERIALS OF DIRECT RECYCLING

(71) Applicant: Nano and Advanced Materials Institute Limited, Hong Kong (HK)

(72) Inventors: Wei HUANG, Hong Kong (HK); Tianjin ZHAO, Hong Kong (HK); Lang WANG, Hong Kong (HK); Qingwen LU, Hong Kong (HK); Shengbo LU, Hong Kong (HK); Chenmin LIU, Hong Kong (HK)

(21) Appl. No.: 19/278,722

(22) Filed: Jul. 23, 2025

Related U.S. Application Data
(60) Provisional application No. 63/753,982, filed on Feb. 5, 2025.

(51) Int. Cl. C22B 7/00; H01M 10/54

(52) U.S. Cl. CPC C22B 7/006; H01M 10/54

(57) ABSTRACT

The present invention proposes new formulas of cathode repairing solution based on deep eutectic solvents to repair the degraded electrode materials from the industrial black mass, the direct recycled electrode materials from the black mass can be included in a close-loop large-scale direct recycling process in a green and low-cost way. Moreover, through the use of the novel deep eutectic solvents of the present invention, the direct recycled cathode reparation is also carried out under mild conditions, reducing operational hazards and adverse impacts to the environment.

### CROSS-REFERENCE TO RELATED APPLICATIONS

The present application claims priority from U.S. Provisional Utility Patent application no. 63/753,982 filed Feb. 5, 2025; the disclosure of which is incorporated by reference in its entirety.

### FIELD OF THE INVENTION

The present invention relates to lithium electrode recycling. In particular, the present invention relates to deep eutectic solvent formulations for repairing the degraded electrode materials from the industrial black mass in a close-loop large-scale direct recycling process.

### BACKGROUND

Direct cathode recycling, a closed-loop approach for recovering and reusing cathode materials from spent lithium-ion batteries, is of high interest in today's sustainability development. This process involves minimal chemical breakdown of the cathode materials into their elemental constituents, and has a multitude of benefits for the recycling economics.

Direct cathode recycling minimizes the breakdown of the cathode materials into elemental constituents, which translates also to minimized waste generation, high sustainability, and low energy consumption.

This process is also cost-effective as it helps conserving finite resources, in particular valuable metals such as lithium, cobalt, and nickel; thereby saving costs and reducing dependence on the mining and refining for these mineral resources.

However, existing direct recycling technologies have several problems. Firstly, a dismantling process is needed in the existing direct recycling processes, which could be labor intensive. Secondly, although there are already improvements as compared to pyro-processing (which requires extreme high heat, i.e., >1,000° C.) and hydro-processing (which requires the use of highly toxic chemicals), the direct recycling processes still requires a solid phase reaction for Li or transition metal replenishment with the use of >300° C. heat. Even so, the reaction could still be uneven, resulting in the sub-optimal performance of the recycled cathodes. The above conditions also inevitably limit the processes' scalability.

Thus, there is a need to improve the direct cathode recycling technologies to minimize environmental impacts and energy consumption through improved processes that require less harsh reaction conditions, more uniform action, and higher scalability.

### SUMMARY OF THE INVENTION

Addressing the above technical insufficiencies, the present invention provides a repairing solution based on a deep eutectic solvent specifically formulated for direct recycling of lithium/sodium batteries.

In accordance with the various embodiments of the present invention, the repairing solution comprises one or more hydrogen bond donors, one or more hydrogen bond acceptors, one or more supporting components, and one or more element replenishment agents providing the replenishment of metal ions including Li, Na, Co, Fe, Ni, and Mn. The deep eutectic solvent has a eutectic point of no higher than 150° C., and a high solvation capability for the element replenishment agents, wherein the deep eutectic solvent at least allows solvation of 5 wt % of element replenishment agents. The Li-ion or Na-ion diffusion coefficient of the deep eutectic solvent is lower than the spent cathodes.

Further, the hydrogen bond donors include the functional groups with active hydrogen atom showing positive charge, or the capability of terminal positive charge from molecular polarity or ionization. The hydrogen bond acceptors include the functional groups with active atom showing negative charge, or the rc system, or other negative charge concentrated sites induced by molecular internal polarity. The hydrogen bond donors and hydrogen bond acceptors are designed to deliver a high rate of element replenishment on the spent cathodes.

In one embodiment, the functional groups of the hydrogen bond donors include amino groups (—NH₂), amide groups (H—N—C═O), carboxyl groups (—COOH), hydroxyl groups (—OH), sulfhydryl groups (—SH) and other common functional groups that are capable of providing active hydrogen for hydrogen bonding; or the components that are able to provide active positive charge, such as Li cation, ammonium cation (NH₄⁺).

In a further embodiment, the structures of the functional groups of the hydrogen bond donors provide no less than one site that are able to form hydrogen bonds with the hydrogen bond acceptors.

In a yet further embodiment, the hydrogen bond donors are selected from urea, thiourea, lithium-containing polyol, sodium-containing polyol, lithium organic/inorganic salts, sodium salts, ammonium salts, or combinations thereof.

In another embodiment, the lithium organic/inorganic components are selected from lithium hydroxide (LiOH), lithium bis(trifluoromethanesulphonyl)imide (LiTFSI), lithium bis(fluorosulfonyl)imide (LiFSI), lithium hexafluorophosphate (LiPF₆), lithium tetrafluoro oxalato phosphate (LiTFOP), lithium citrate or combinations thereof.

In yet other embodiment, the sodium salts are selected from sodium bis(trifluoromethanesulphonyl)imide (NaTFSI), sodium bis(fluorosulfonyl)imide (NaFSI), sodium hexafluorophosphate (NaPF₆), sodium difluoro(oxalate)borate (NaDFOB), sodium citrate or combinations thereof.

In another embodiment, the ammonium salts are selected from ammonium bis(trifluoromethanesulphonyl)imide (NH₄TFSI), ammonium bis(fluorosulfonyl)imide (NH₄FSI), ammonium hexafluorophosphate (NH₄PF₆), or a combination thereof.

In another embodiment, the functional groups are capable of reducing high-valence Fe/Co/Mn structures by valences of at least 1.

In yet another embodiment, the functional groups of the hydrogen bond acceptors include carbonyl groups (C═O), cyanide groups (C═N), amino groups (—NH₂), hydroxyl groups (—OH), or Lewis base with single electron pair, conjugated system containing w bond, or strongly negatively-charged anions.

In a further embodiment, the structures of the functional groups of the hydrogen bond acceptors provide no less than one site that are able to form the hydrogen bond with the hydrogen bond donors.

In another further embodiment, the hydrogen bond acceptors are selected from betaine, choline chloride, halide anion-containing inorganic salts, zwitterions with w-w stacking effect, or combinations thereof.

In another embodiment, the anion-containing inorganic salts are selected from LiCl, LiF, LiBr, LiI, LiNO₃, NaCl, NaBr, NaI, or combinations thereof.

In another embodiment, the zwitterions with if-if stacking effect is 1,8-Bis(dimethylamino)-4,5-dihydroxynaphthalene or similar conjugated structure or the functional structure of small graphene-type conjugated system.

In a further embodiment, the supporting components provide promoting effect for the formation of DES, such as the ethylene glycol for the utilization of lithium ethylene glycol, the water for the LiCl with weak HBDs, or other liquid phase supporting components for helping the deep eutectic solvent formation.

In a yet further embodiment, the element replenishment agents are selected from LiOH, NaOH, CoO, Fe₂O₃, Mn₂O₃, NiO, Ni₂O₃, or combinations thereof.

In another embodiment, the repairing solution based on the deep eutectic solvent repairs the spent cathode for the capacity recovery, and wherein the spent positive electrode powder is at least one selected from lithium iron phosphate (LFP), lithium cobalt oxide (LCO), ternary nickel cobalt manganese oxide (NCM), lithium vanadium phosphate (LVP), lithium-rich manganese-based materials (LRMO), lithium manganite (LMO), lithium iron manganese phosphate (LFMP), sodium vanadium phosphate (NVP), sodium iron phosphate (NFP), or Prussian blue analogues.

### BRIEF DESCRIPTION OF THE DRAWINGS

FIGS. 1A and 1B provides an illustration of the preparation of the deep eutectic solvent of the present invention and the process of repairing the spent cathode. FIG. 1A illustrates the concept of using deep eutectic solvent formulation to change the solid-state metal compounds into liquid phase; and FIG. 1B illustrates the immersion of extracted cathodes into the metal-deep eutectic solvent chelate solution obtained according to FIG. 1A to recover the lost metal ions in the cathode.

FIGS. 2A and 2B provides a comparison of the existing battery recycling processes with the direct recycling using the deep eutectic solvent of the present invention. FIG. 2A compares the demand of raw materials for the production of 1 tonne of LiCoO₂ cathode under different processes; and FIG. 2B compares the production conditions of the different processes.

FIG. 3 provides a schematic illustration of the reduction effect of the deep eutectic solution of the present invention on the defects caused by the oxidized transition metal ions for releasing lithium ion pathway in spent cathode.

FIG. 4 tabulates the composition of an exemplary ethylene glycol-lithium-based deep eutectic solvent of the present invention.

FIG. 5 shows comparatively the performances of the electrodes respectively recovered with EG-Li-based DES, and the degraded electrode before repairing for the first several cycles, in terms of their specific capacities and coulombic efficiencies.

FIG. 6 shows the comparative galvanostatic profiles of voltage against specific capacity of the spent LCO cathode and the EG-Li-based DES-repaired LCO cathode.

FIG. 7 depicts the Raman spectroscopy results on spent LCO.

FIG. 8 depicts the Raman spectroscopy results on Repaired-LCO (R-LCO) with LiOH cleaning the Al impurity followed by EG-Li treatment.

FIG. 9 depicts the Raman spectroscopy result on Annealing Repaired-LCO (AR-LCO) with LiOH cleaning the Al impurity followed by EG-Li treatment.

FIG. 10 depicts the X-ray diffraction analysis result on AR-LCO with LiOH cleaning the Al impurity followed by EG-Li treatment.

FIG. 11 tabulates the composition of an exemplary urea-LiCl deep eutectic solvent of the present invention.

FIG. 12 shows comparatively the plots of heat flow against temperature for urea, urea-LiCl and LiCl respectively. In particular, the addition LiCl distinctly reduces the melting heat absorption of urea and LiCl, respectively, and generates low heat absorption during the whole heating-melting process in the system, demonstrating behavior of deep eutectic solvents.

FIG. 13 shows comparatively the cycling performances of the raw spent LCO cathode and the LCO cathode recovered with urea-LiCl DES respectively, in terms of their specific capacities and coulombic efficiencies.

FIG. 14 shows the galvanostatic profiles of voltage against specific capacity of the spent LCO cathode and the urea-LiCl DES-repaired LCO cathode.

FIGS. 15A to 15D depict the X-ray diffraction analysis of LCO repaired by urea-LiCl deep eutectic solution. FIG. 15A depicts the entire spectrum of the X-ray diffraction analysis of the spent LCO and LCO repaired by urea-LiCl deep eutectic solution; and FIGS. 15B, 15C and 15D are zoom-ins of sections of the spectrum shown in FIG. 15A, from 14-18° for the phase appeared after repairing (FIG. 15B), 17-20° for the crystal facet of (003) (FIG. 15C) and 43-47° for the crystal facet of (104) (FIG. 15D) respectively.

FIG. 16A to 16C provides an overview of another exemplary deep eutectic solvent, urea-lithium citrate (LiCTT)-betaine DES. FIG. 16A depicts the chemical structures of three major components of the urea-LiCTT-betaine DES, namely urea, LiCTT and betaine. FIG. 16B tabulates the molar ratio of the components of the urea-LICTT-betaine DES (lower row) and the urea-betaine DES control setup (upper row). FIG. 16C tabulates and compares the cobalt and lithium content of the pre-repair LCO and LCO after repaired by urea-LiCTT-betaine DES.

FIG. 17 shows the galvanostatic profiles of voltage against specific capacity of the spent LCO cathode and urea-LiCTT-betaine DES-repaired LCO cathode.

FIG. 18 shows the repeated high-rate cycling performance (2C/2C) of the LCO cathode recovered with urea-LiCTT-betaine DES respectively, in terms of their specific capacities and coulombic efficiencies.

FIGS. 19A and 19B show the X-ray diffraction analysis of spent NCM532 cathode and NCM532 repaired by LiNO₃—LiOH deep eutectic solution, and NCM532 repaired by the LiNO₃—LiOH deep eutectic solution with 5 wt % CoO and 5 wt % MnO₂ as element replenishment agents. FIG. 19A shows the entire spectrum of the X-ray diffraction analysis of spent NCM532 and NCM532 repaired by LiNO₃—LiOH deep eutectic solution. FIG. 19B tabulates and compares the angles of peak signals occurrences in the spectrum with particular emphasis on the (003) and (104) peaks, and the ratios of intensity of both peak signals, which reveals the level of Li—Ni atomic mixture.

FIG. 20 shows the galvanostatic profiles of voltage against specific capacity of the spent and LiNO₃—LiOH DES-repaired NCM532 cathodes.

FIG. 21 shows comparatively the cycling performances (1C/1C) of the raw spent NCM532 cathode and NCM532 cathode recovered with LiNO₃—LiOH DES respectively, in terms of their specific capacities and coulombic efficiencies.

FIGS. 22A and 22B shows the galvanostatic profiles of voltage against specific capacity of spent cathodes. FIG. 22A corresponds to the galvanostatic profile of spent LCO cathode; and FIG. 22B corresponds to the galvanostatic profile of spent NCM cathode.

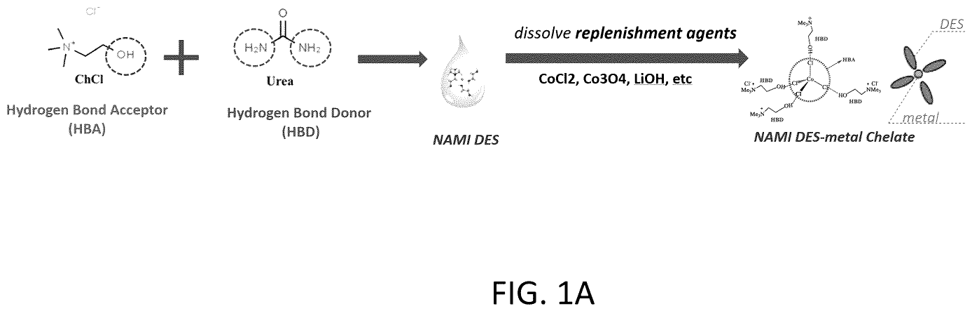

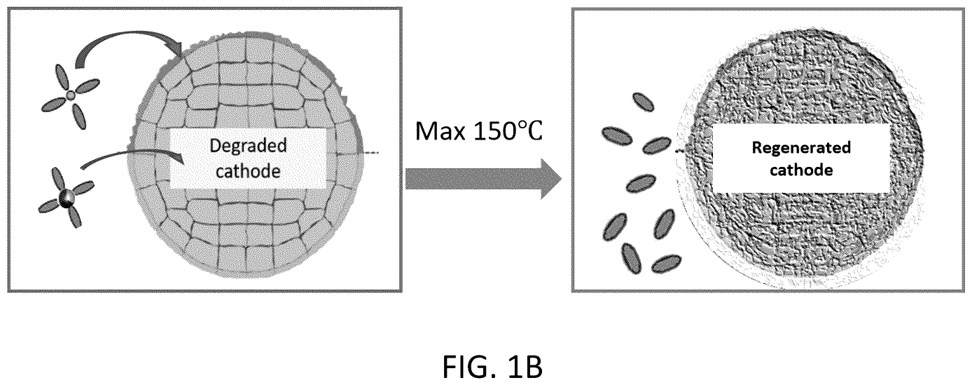

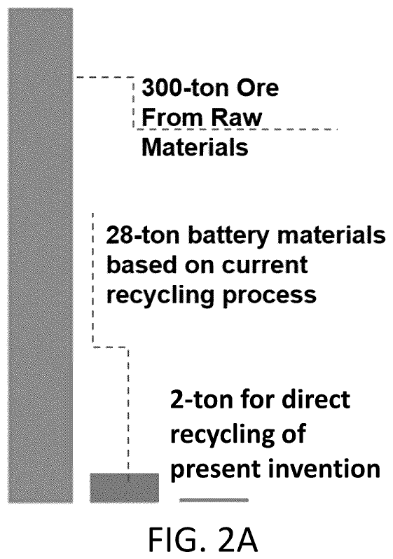

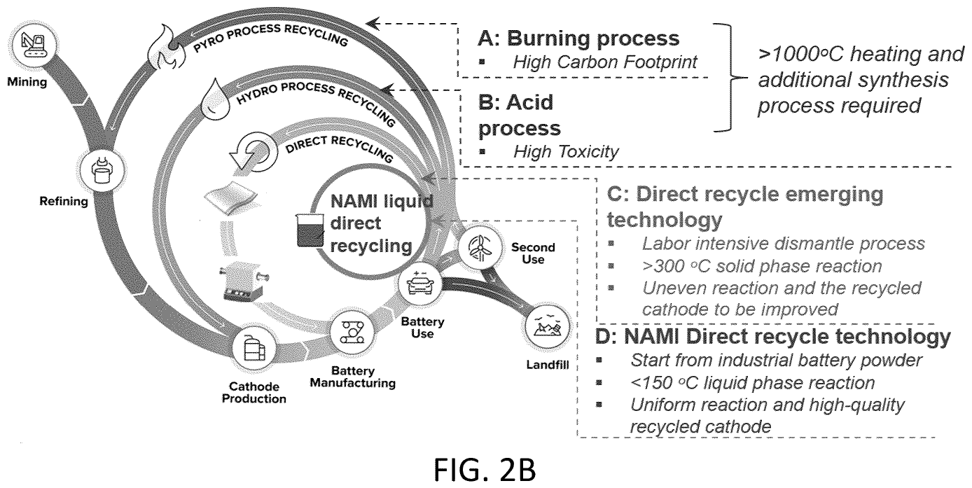

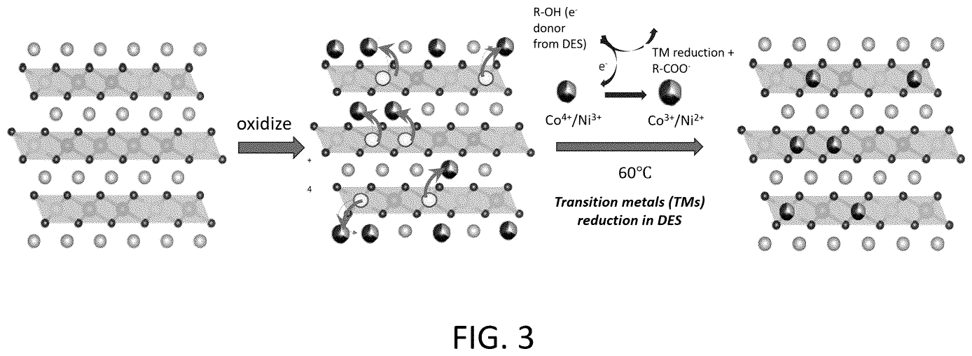

### DETAILED DESCRIPTION

In accordance with the various embodiments, the present invention provides a cathode repairing solution based on deep eutectic solvent specifically formulated for direct cathode recycling with minimal toxicity and mild conditions.

The deep eutectic solvent (DES) is formulated such that the spontaneous diffusion of Li/Na ions and transition metals into the cathode structure is optimized for reparation.

Additionally, the DES is superior in terms of uniform reaction and replenishment of the spent cathodes. Typically coupled with an annealing process, the DES-annealing treatment mitigates the condition of Li or transitional metal replenishment, while also facilitates lattice re-structuring.

Two main challenges of repairing spent cathode with more than 20% degradation are: (i) the replenishment of the metal ions lost; and (ii) the blockage of lithium ion pathway due to the presence of oxidized metal ions. The DES in accordance with the various embodiments of the present invention addresses both problems.

Firstly, the DES is fabricated by mixing specific hydrogen bond acceptors and specific hydrogen bond donors, in which solid-state metal oxide compounds acting as replenishment agents are dissolved to form a liquid phase DES-metal chelate solution. The extracted cathodes are then immersed into the DES-metal chelate solution, in which the solvated lithium ions and transition metal ions diffuse into the vacancies of the cathode as carried by the DES; and the DES peels off after replenishment under a temperature of no higher than 150° C.

The DES formulation is formulated such that the affinities between the metal ion and DES is optimal for diffusion into the cathode crystal lattice and stay as replenishment.

Secondly, the DES formulation comprises reducing functional groups. Through immersing the spent cathode materials into the DES of the present invention, the reducing functional groups are introduced into the cathode crystals, reducing the defective oxidized metal ions there within. This in turn re-opens the otherwise blocked lithium ion pathways.

By the specific designs of the DES, not only is the DES able to replenish the lost metal ions, it also boosts the performances of the repaired cathodes for resuming the lithium ion pathways.

Coupled with the mild conditions required of the direct cathode reparation (as the eutectic point is lower than 150° C.) and the requirement of chemicals of low to no toxicity for the fabrication of the DES, not only is the DES of the present invention superior in cathode recovery functionalities, it also possesses great potential with high scalability and high cost-effectiveness for large-scale production and application.

### Examples

Exemplary DES formulations are fabricated and applied to spent electrodes. BM-1 cathode denotes a spent lithium cobaltate (LCO) cathode; and BM-2 denotes a spent ternary nickel cobalt manganese (NCM) cathode. Tests and conducted on the spent cathodes and repaired cathodes to observe the change in performances.

### Example 1—EG-Li-based DES

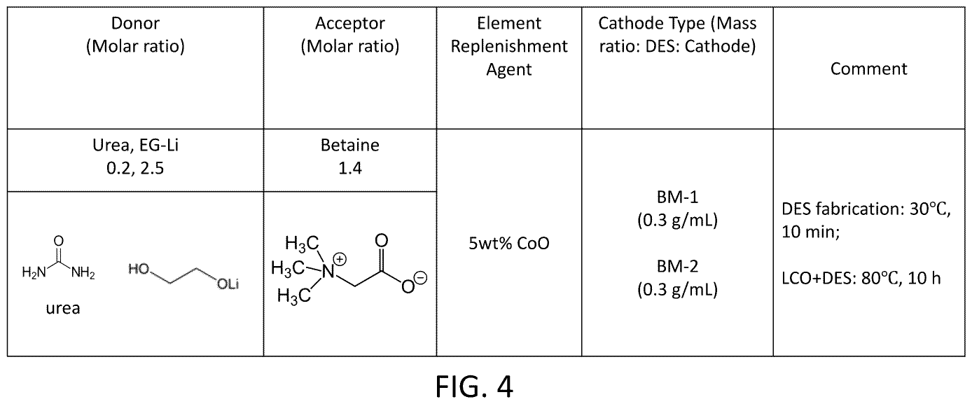

Referring to FIG. 4. The first formulation is a DES based on ethylene glycol-lithium as the main hydrogen bond donor, with betaine as the acceptor, and cobalt oxide as the element replenishment agent.

It should be noted that the DES fabrication requires only a slightly elevated room temperature of approximately 30° C.; and the direct cathode recycling process requires only a mild heat of approximately 80° C.

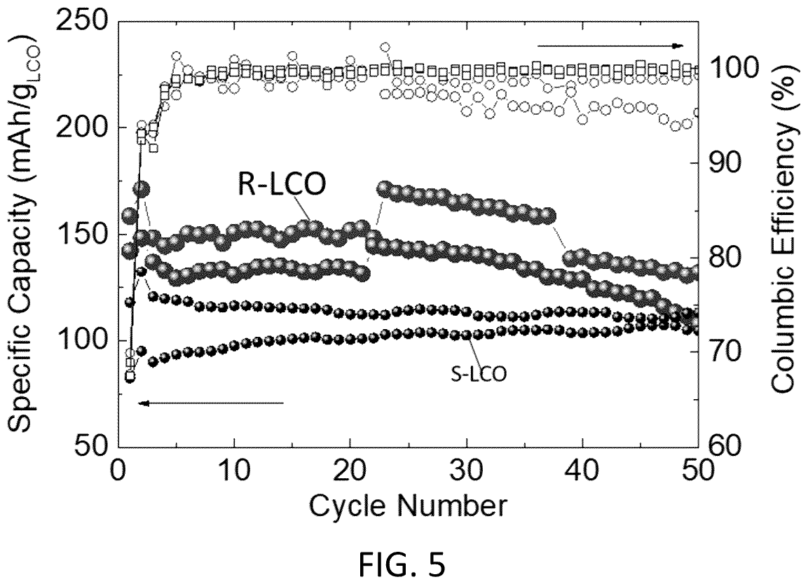

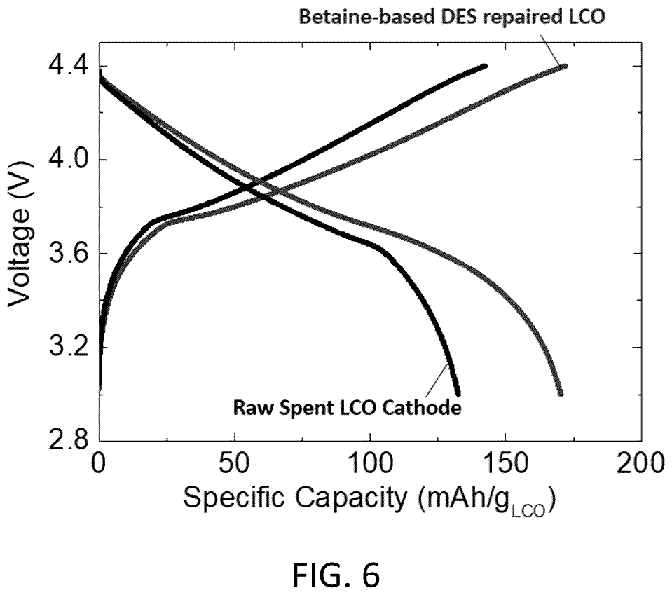

The comparative performances of the batteries for the initial several cycles before and after reparation in the DES described above are shown in FIGS. 5 and 6. A significant improvement in the performances and parameters is observed, indicating a promising reparation effect brought by the DES of the present invention.

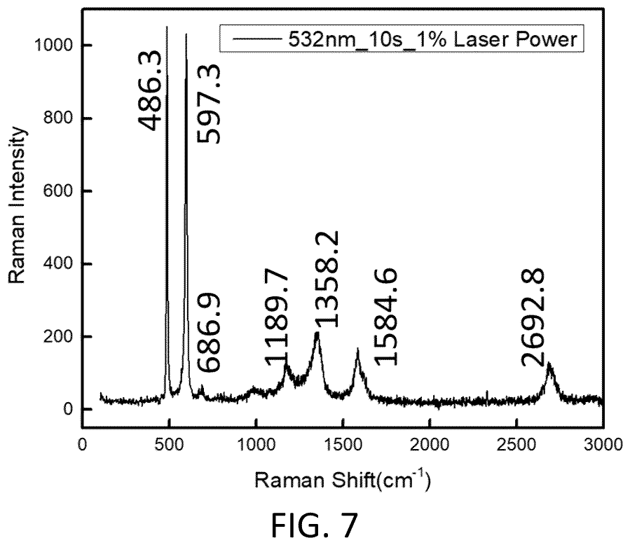

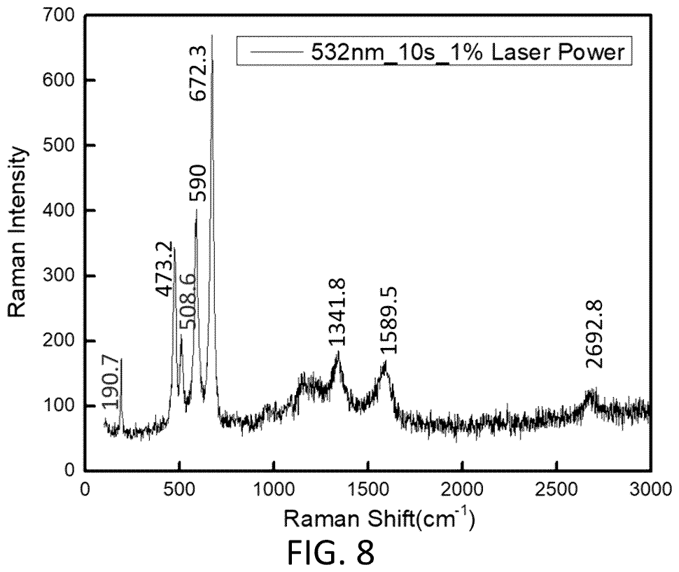

Raman analyses are carried out on the spent LCO and the repaired LCO with LiOH cleaning and EG-Li treatment. The Raman analyses results of the spent LCO and the repaired LCO with LiOH cleaning Al and EG-Li treatment are shown in FIGS. 7 and 8 respectively.

Referring to FIG. 7, the Raman corresponding peaks are as follows:
486.3 cm⁻¹: Hexagonal LCO O3 Phase

$${A}_{1 g}^{h}$$

mode)
597.3 cm¹: Hexagonal LCO O3 Phase

$${E}_{g}^{h}$$

mode
686.9 cm⁻¹: Octahedral site

$${A}_{g}^{1}$$

mode of Co₃O₄
1189.7 cm⁻¹: Oxygen-containing functional groups (C—O—C) 1358.2 cm⁻¹: D-band of carbon
1584.6 cm⁻¹: G-band of carbon
2692.8 cm⁻¹: 2D-band of carbon

Referring to FIG. 8, the Raman corresponding peaks are as follows:
473.2 cm⁻¹: Hexagonal LCO O3 Phase

$${A}_{1 g}^{h}$$

mode)
590 cm⁻¹: Hexagonal LCO O3 Phase

$${E}_{g}^{h}$$

mode
672.3 cm⁻¹: Octahedral site

$${A}_{g}^{1}$$

mode of Co₃O₄
1341.8 cm⁻¹: D-band of carbon
1589.5 cm⁻¹: G-band of carbon
2692.8 cm⁻¹: 2D-band of carbon

In addition, there are new Raman corresponding peaks, namely spinel-structured oxide CO₃O₄ (Fd-3m)

$${F}_{2 g}^{1}$$

at 190.7 cm⁻¹; and hexagonal crystal (P-3m) peak of CoOOH at 508.6 cm⁻¹.

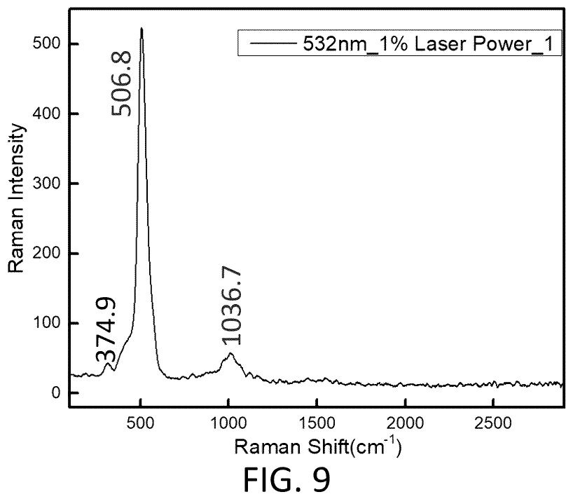

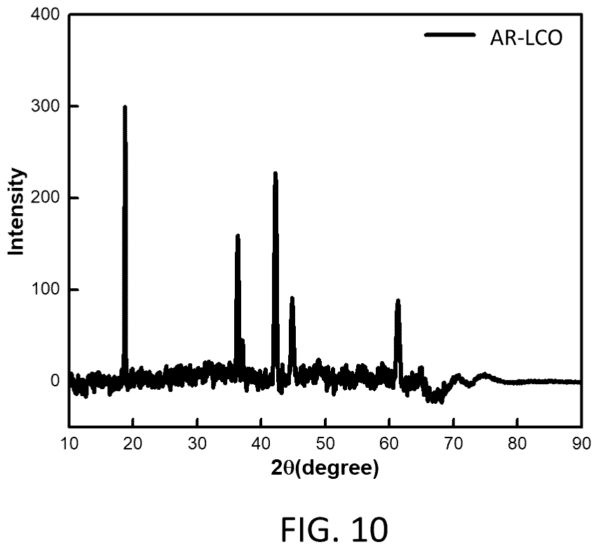

Referring to the Raman analysis on AR-LCO with LiOH cleaning Al and EG-Li treatment as shown in FIG. 9, there are Raman corresponding peaks of hexagonal crystal (P-3m) peak of CoOOH at 508.6 cm⁻¹ and oxygen-containing functional groups (C—O—C) at 1036.7 cm⁻¹, with a Raman corresponding new peak of hexagonal crystal (P-3m) peak of CoOOH at 374.9 cm⁻¹.

### Example 2—Urea-LiCl-Based DES

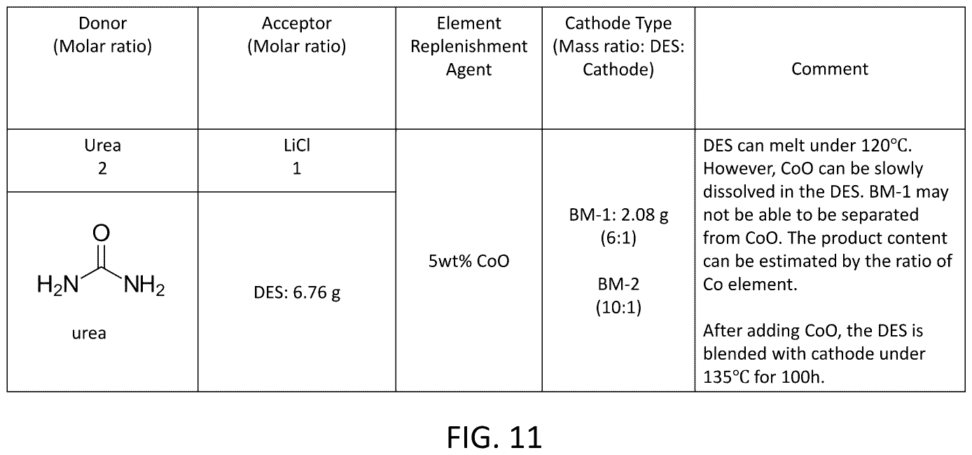

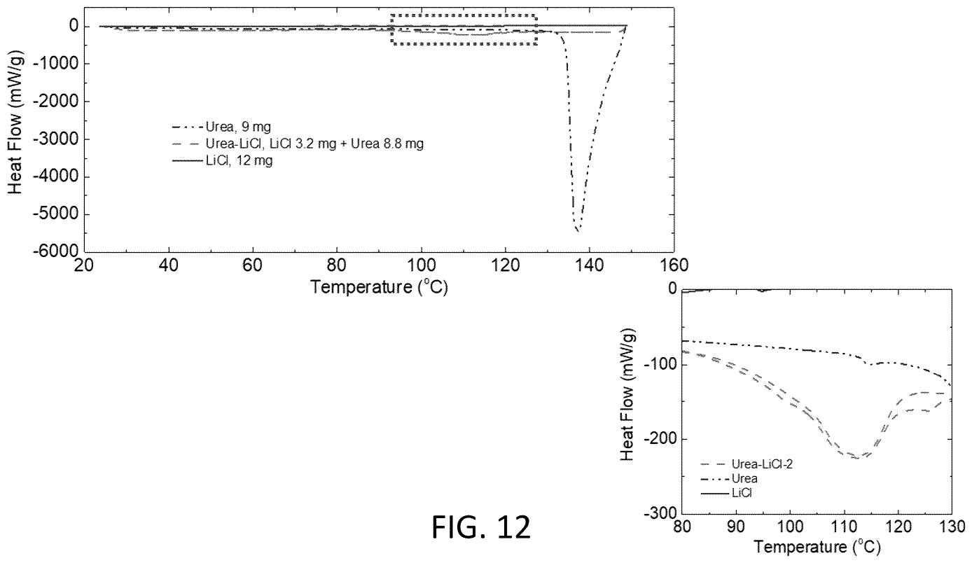

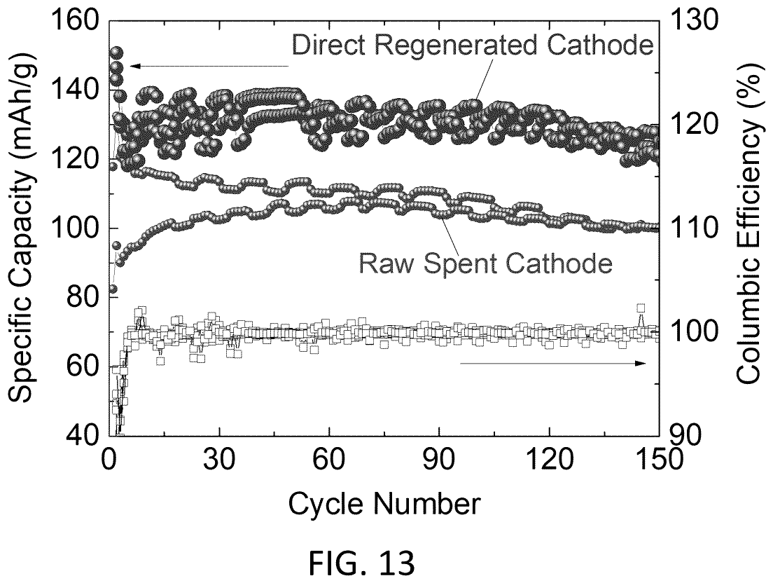

Another exemplary DES is designed, with urea as the hydrogen bond donor, lithium chloride as the hydrogen bond acceptor, and cobalt oxide as the element replenishment agent. The details as to the molar ratios of the ingredients are specified in FIG. 11.

Similarly, it should be noted that both the fabrication of the DES and the direct cathode recycling process require temperatures lower than 150° C., as compared to 300° C. or above in existing direct cathode recycling technologies. The ingredients involved are also of relatively low toxicity and expose little to no environmental hazard.

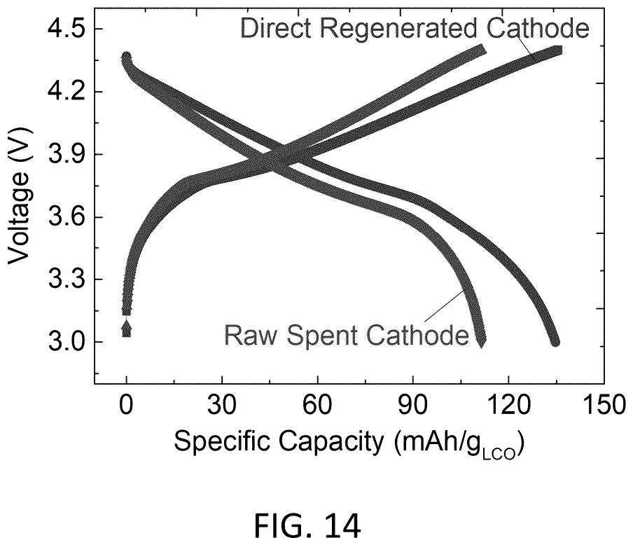

As shown in FIG. 14, there is also significant improvements in the reversible capacity (specifically voltage and specific capacity), evidencing the effectiveness of the DES of the present invention in facilitating direct cathode reparation and replenishment.

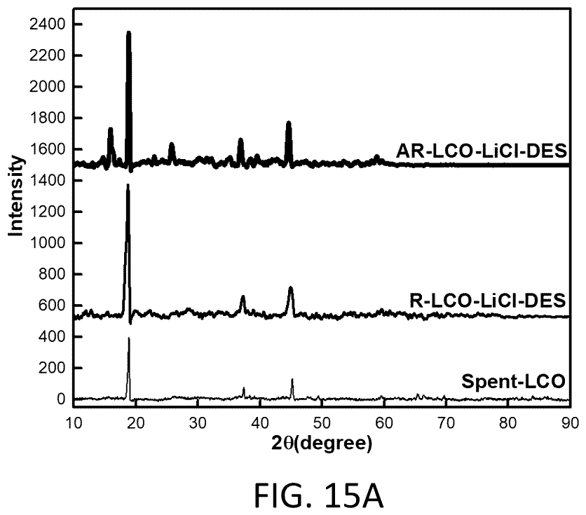

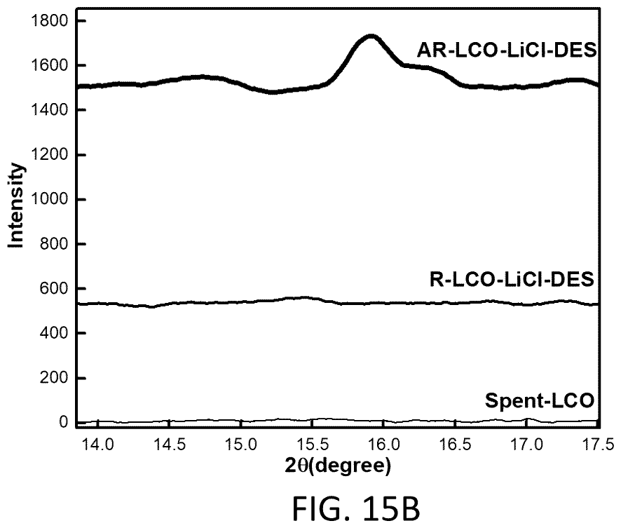

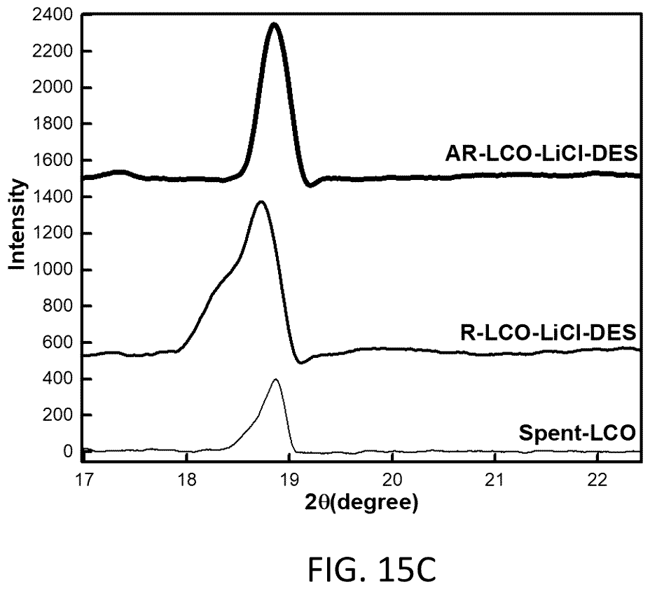

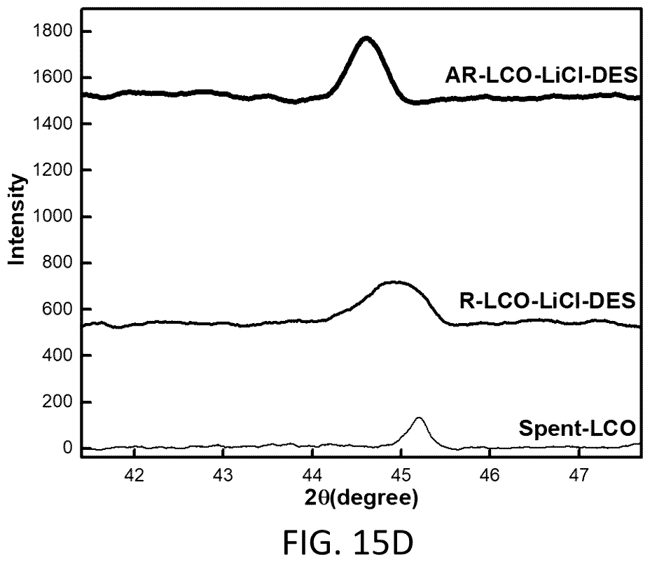

Shown in FIGS. 15A to 15D are X-ray diffraction (XRD) analyses of the LCO repaired by urea-LiCl DES. Particularly, FIG. 15C shows the range of angle from 17-20° for (003) facet of the XRD spectrum, where the otherwise asymmetric peak demonstrated by the spent LCO becomes symmetric post-repair, which is a sign that the lithium defects have decreased. In particular, the asymmetry of the peak and displacement of the peak as shown in the XRD analysis of the spent LCO in FIG. 15C indicates the occurrence of high-valency Li, which is effectively reduced to its lower-valency state post-annealing and DES treatment.

Similarly, in FIG. 15D which show the range of angle from 43-47° for (104) of the XRD spectrum, the >45° peak demonstrated by the spent LCO signifies a Co defect. The Co defect is subsequently recovered post-repairing, as seen in the shift of the peak back to the conventional 44.5° position.

### Example 3—Urea-LiCTT-Betaine DES

Another embodiment of the deep eutectic solvent utilizes lithium citrate tribasic tetrahydrate (LiCTT) as hydrogen bond donor and betaine as hydrogen bond acceptor. Cobalt oxide is selected as the element replenishment agent.

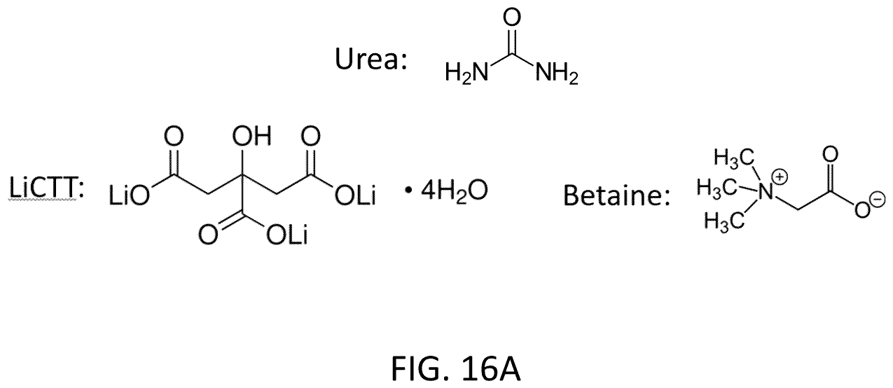

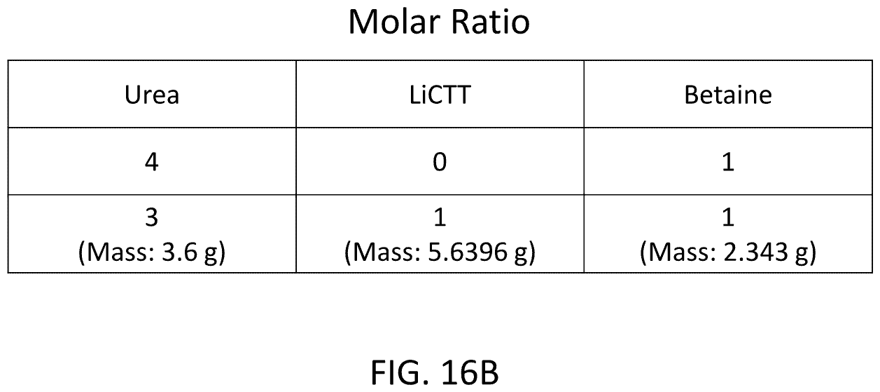

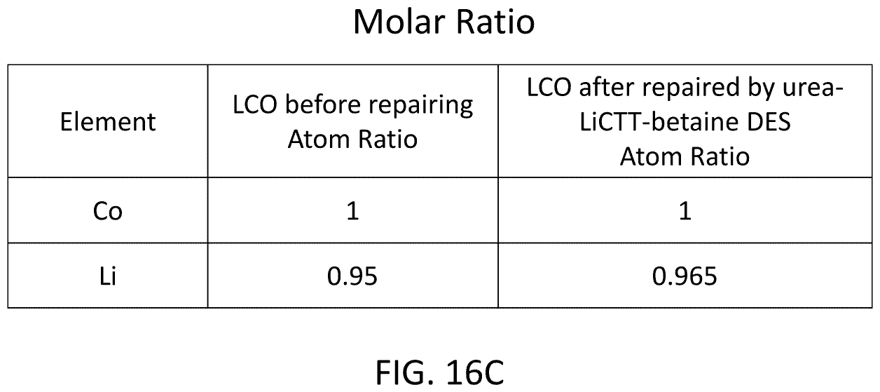

A spent LCO electrode is used to assess the repairing performances of the LiCTT-betaine DES. Please refer to FIG. 16B for the molar ratio of the formulation (indicated by the lower row; the upper row corresponds to the urea-betaine DES control setup), and FIG. 16C for a comparison of the cobalt-to-lithium ratios between the pre-repair LCO and the urea-LICTT-betaine DES-treated LCO.

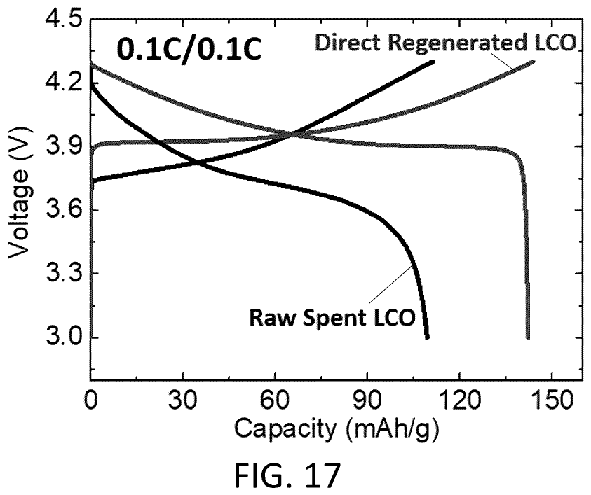

Again, it is observed from the galvanostatic profile as shown in FIG. 17 comparing the performances of the raw spent LCO and urea-LiCTT-betaine DES-treated LCO that the treatment results in significantly improved performances.

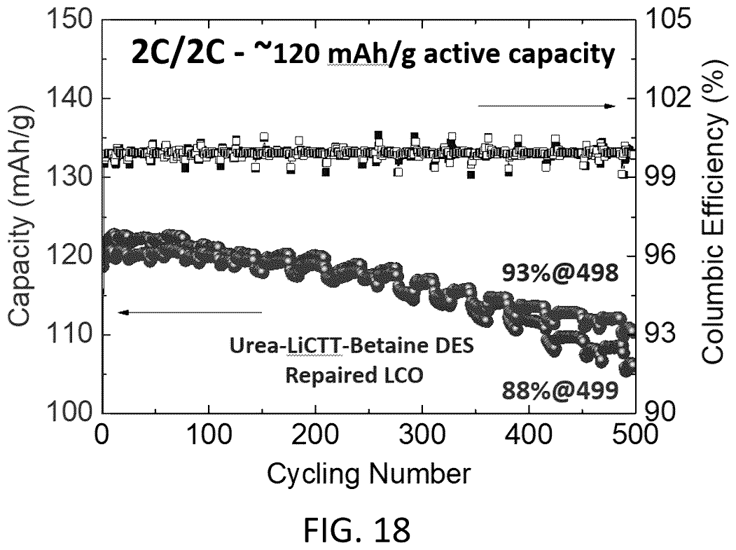

Similarly, FIG. 18 shows that in terms of both coulombic efficiency and specific capacity, the urea-LiCTT-betaine DES-treated LCO displays a stability when cycling under 2C/2C.

### Example 4—LiNO₃—LiOH DES

A deep eutectic solvent with a LiNO₃—LiOH system with element replenishment agent of a mixture of 5 wt % CoO and 5 wt % MnO₂ is devised. LiOH can be described as the hydrogen bond donor and LiNO₃ can be described as the hydrogen bond acceptor; however a more accurate and generic description of the system is that the cation in the system (i.e. Li⁺) acts as the hydrogen bond donor, and the anion in the system (i.e. OH⁻ and NO₃⁻) act as the hydrogen bond acceptors.

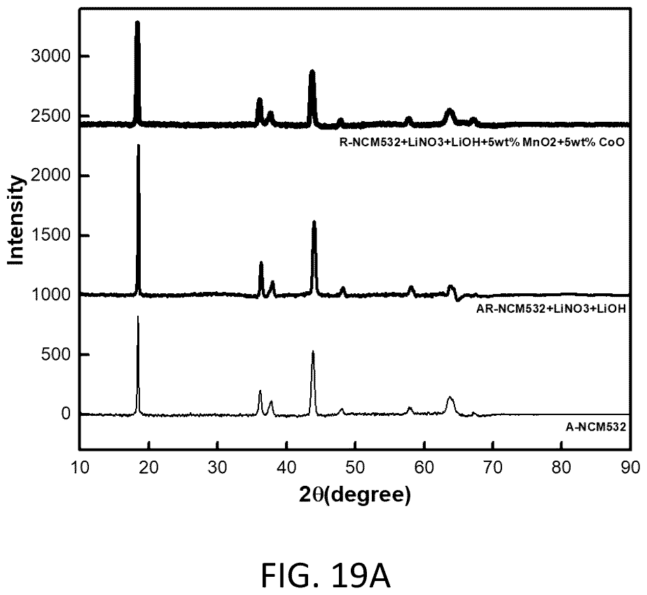

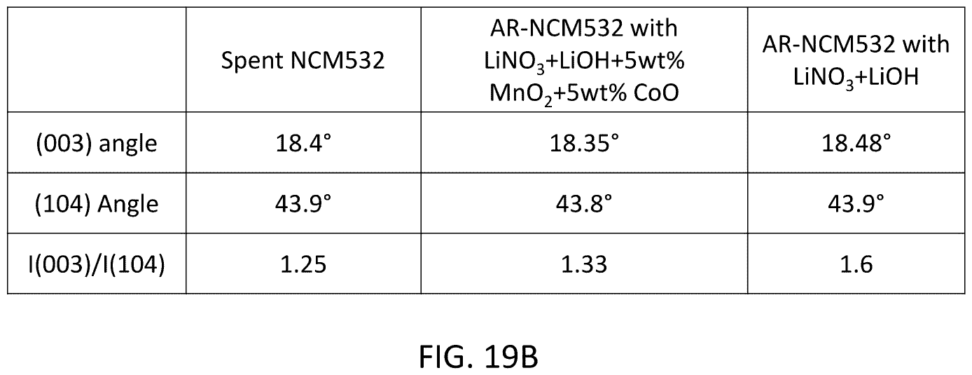

The repairing properties is tested on a ternary nickel cobalt manganese (NCM) electrode. X-ray diffraction analyses of the NCM electrode pre- and post-LiNO₃—LiOH DES treatment is provided in FIG. 19A.

FIG. 19B tabulates and compares the angles of peak signal occurrence in the XRD for the pre- and post-LiNO₃—LiOH DES treatment NCM electrodes, and a ratio of the intensity values of the peak values. This ratio indicates the level of mixture of Li—Ni atoms. In general, a higher ratio corresponds to a higher structural order of the lattice and a lower Li—Ni mixture, which in turn implies better recovery of the electrode. As such, it is observed that the NCM electrode has a significant improvement in lattice order post-annealing and LiNO₃—LiOH DES treatment, as indicated by the increased ratio.

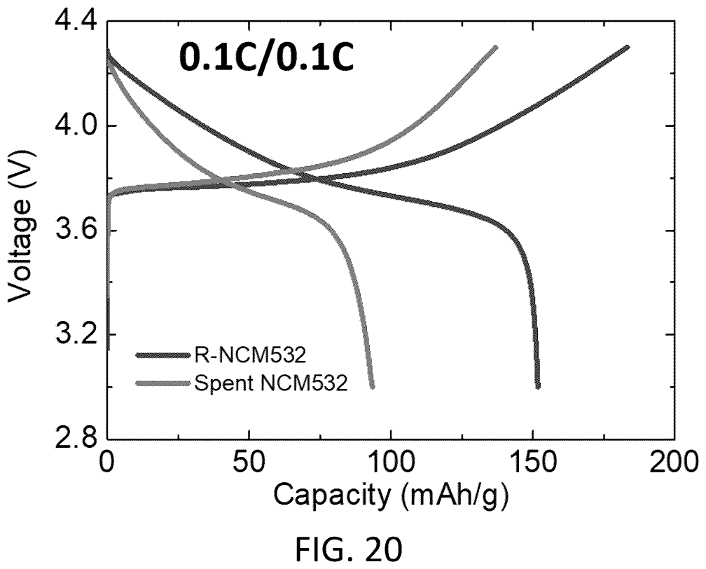

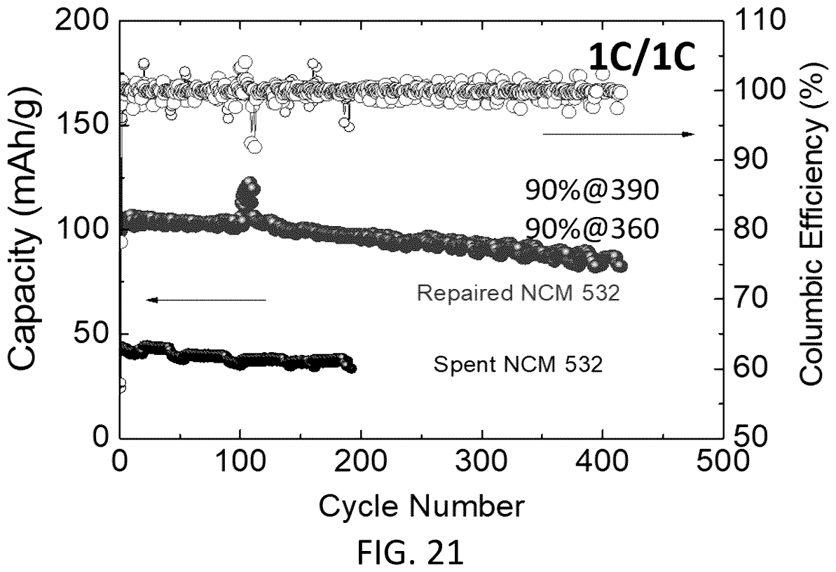

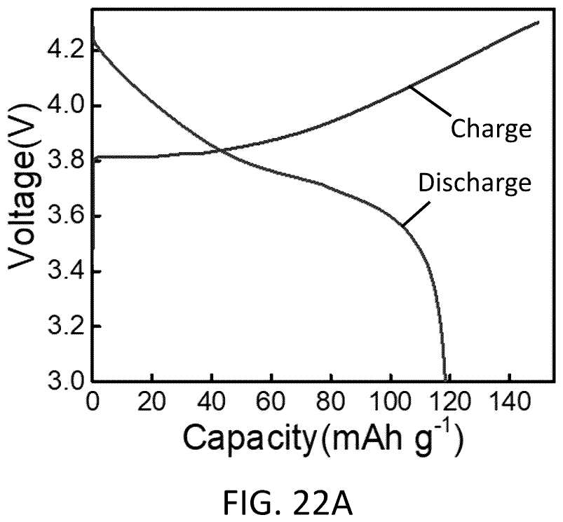

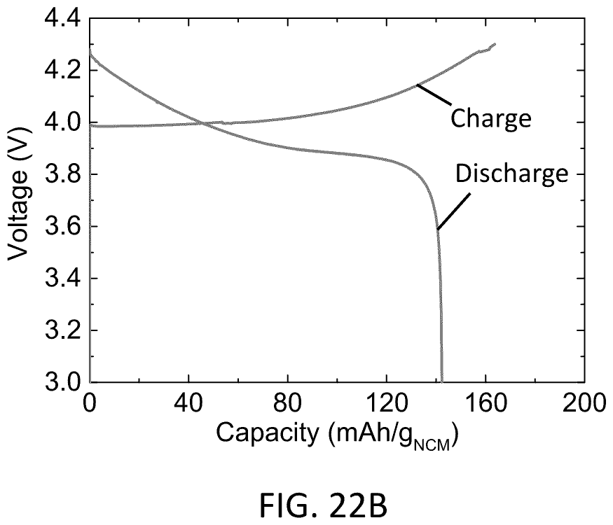

FIGS. 20 and 21 show, through the galvanostatic profiles, coulombic efficiency and specific capacity, that LiNO₃—LiOH DES treatment is effective in restoring the NCM electrode performance to a higher, more stable level.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A repairing solution based on the deep eutectic solvent for repairing the degraded electrode materials with spent cathodes in the direct recycling process of lithium or sodium batteries, comprising:
hydrogen bond donors;
hydrogen bond acceptors; and
element replenishment agents;
wherein the deep eutectic solvent has a eutectic point no higher than 150° C.;
wherein the deep eutectic solvent is capable of solvation of element replenishment agents of at least 5 wt %;
wherein the element replenishment agents provide replenishment of metal ions selected from Li, Na, Co, Fe, Ni, Mn, or combinations thereof,
wherein the deep eutectic solvent has a Li⁺ ion diffusion coefficient or Na⁺ diffusion coefficient lower than the Li⁺ ion diffusion coefficient or Na⁺ diffusion coefficient of the spent cathodes;
wherein the hydrogen bond donors possess functional groups with active hydrogen atom showing positive charge, or the capability of terminal positive charge from molecular polarity or ionization;
wherein the hydrogen bond acceptors possess functional groups with active atom showing negative charge, a π-system, or other negative charge-concentrated sites induced by molecular internal polarity; and
wherein the hydrogen bond donors or hydrogen bond acceptors provide capability of reduction and element replenishment capability for spent cathodes with battery capacities of lower than 80% of the original values.

2. The repairing solution of claim 1, wherein the functional groups of the hydrogen bond donors are selected from:
functional groups providing active hydrogen for hydrogen bonding; or
functional groups containing components that are able to provide positive charge.

3. The repairing solution of claim 2, wherein the functional groups of the hydrogen bond donors provide no less than 1 hydrogen bond-forming site with the hydrogen bond acceptors.

4. The repairing solution of claim 3, wherein the hydrogen bond donors are selected from urea, thiourea, lithium-containing polyol, sodium-containing polyol, lithium salts, sodium salts, ammonium salts, or combinations thereof.

5. The repairing solution of claim 4, wherein the lithium salts are selected from lithium bis(trifluoromethanesulphonyl)imide (LiTFSI), lithium bis(fluorosulfonyl)imide (LiFSI), lithium hexafluorophosphate (LiPF₆), lithium tetrafluoro oxalato phosphate (LiTFOP), lithium hydroxide (LiOH), lithium citrate, or combinations thereof.

6. The repairing solution of claim 4, wherein the sodium salts are selected from sodium bis(trifluoromethanesulphonyl)imide (NaTFSI), sodium bis(fluorosulfonyl)imide (NaFSI), sodium hexafluorophosphate (NaPF₆), sodium difluoro(oxalate)borate (NaDFOB), sodium citrate, or combinations thereof.

7. The repairing solution solvent of claim 4, wherein the ammonium salts are selected from ammonium bis(trifluoromethanesulphonyl)imide (NH₄TFSI), ammonium bis(fluorosulfonyl)imide (NH₄FSI), ammonium hexafluorophosphate (NH₄PF₆), or a combination thereof.

8. The repairing solution solvent of claim 3, wherein the functional groups reduce the valences of Fe, Co, or Mn structures by at least 1.

9. The repairing solution of claim 1, wherein the functional groups of the hydrogen bond acceptors include carbonyl groups (C═O); cyanide groups (C═N); amino groups (—NH₂); hydroxyl groups (—OH); Lewis base with single electron pair; conjugated system containing w bond; or strongly negatively-charged anions.

10. The repairing solution of claim 9, wherein the functional groups of the hydrogen bond acceptors provide no less than 1 hydrogen bond-forming site with the hydrogen bond donors.

11. The repairing solution of claim 10, wherein the hydrogen bond acceptors are selected from betaine; choline chloride; halide anion-containing inorganic salts; zwitterions with π-π stacking effect; or combinations thereof.

12. The repairing solution of claim 11, wherein the anion-containing inorganic salts are selected from LiCl; LiF; LiBr; LiNO₃; LiI; NaCl; NaBr; NaI; or combinations thereof.

13. The repairing solution of claim 11, wherein the zwitterions with if-if stacking effect is 1,8-bis(dimethylamino)-4,5-dihydroxynaphthalene.

14. The repairing solution of claim 1, wherein the element replenishment agents are selected from LiOH; NaOH; CoO; Fe₂O₃; Mn₂O₃; NiO; Ni₂O₃; MnO₂; or combinations thereof.

15. The repairing solution in claim 1, wherein the spent cathode is at least one selected from the group consisting of lithium iron phosphate (LFP), lithium cobaltate (LCO), ternary nickel cobalt manganese (NCM), lithium vanadium phosphate (LVP), lithium-rich manganese-based materials (LRMO), lithium manganite (LMO), lithium iron manganese phosphate (LFMP), sodium vanadium phosphate (NVP), sodium iron phosphate (NFP) and Prussian blue analogues.
